(19) United States
(12) Patent Application Publication
(10) Pub. No.: US 2012/0237778 A1
(43) Pub. Date: Sep. 20, 2012

(54) AQUEOUS COMPOSITION FOR CORROSION RESISTANT FASTENER COATINGS

(75) Inventors: XUEPU MAO, Guangdong (CN); Jeffrey Hugh Hamilton, Lincoln University, PA (US); Michael J. Witsch, Norwood, PA (US); Craig King Hennessey, Avondale, PA (US)

(73) Assignee: E. I. DU PONT DE NEMOURS AND COMPANY, Wilmington, DE (US)

(21) Appl. No.: 13/232,263

(22) Filed: Sep. 14, 2011

Related U.S. Application Data
(60) Provisional application No. 61/383,111, filed on Sep. 15, 2010.

(51) Int. Cl. C09D 5/08; C08K 5/32; C08K 3/34; C09D 127/18; C08K 3/32

(52) U.S. Cl. 428/422; 524/520; 524/417; 524/443; 524/444; 524/456; 524/259

(57) ABSTRACT

The present invention provides aqueous coating compositions for metal substrates, where the coating provides improved corrosion resistance compared to conventional aqueous corrosion resistant coatings. The coating comprises (a) one or more functionalized acrylic polymer; (b) one or more melamine resin; (c) one or more perfluorinated polymer; and (d) one or more dispersing polymer selected from the group consisting of polyimide (P1), polyamideimide (PAI), polyether sulfone (PES), polyphenylene sulfide (PPS), and a mixture thereof. The composition is particularly useful for fasteners, such as nuts and bolts, used in marine environments.

### FIELD OF THE INVENTION

This invention relates to aqueous fluoropolymer coating compositions and substrates coated with these compositions which have improved corrosion resistance. In particular, the invention provides coating compositions for fasteners, such as nuts and bolts, where the coating provides improved corrosion resistance compared to conventional coatings, while maintaining both good coating-substrate adhesion and the ability to release (coating-coating release) so that the nuts and bolts can be unscrewed, even after exposure to salt water environments.

### BACKGROUND OF THE INVENTION

Fluoropolymer resins, and especially perfluoropolymer resins, are known for their low surface energy and non-stick properties as well as thermal and chemical resistance. However, fluoropolymer coatings often show lower hardness and are not generally suitable as the sole binder in the most demanding seawater applications because they fail to provide sufficient corrosion resistance. Moreover, perfluorinated polymers are difficult to incorporate homogeneously with co-binders into both the wet aqueous formulation and also into the dried coating. Incompatibilities in the binder composition generally have an adverse effect on the corrosion resistance properties. It has long been desirable to achieve superior corrosion resistance for metal substrates combined with the release properties associated with fluoropolymers. Of particular concern to achieving coated metal substrates with longer service life in seawater applications is the coated substrate's ability to withstand corrosion.

Fluoropolymer coatings facilitate low friction sliding contact in many applications. However, the attributes that result in desirable non-stick properties also result in difficulties in getting non-stick coatings to adhere well to the substrate. This difficulty is exacerbated by the damaging effects of corrosion. It is important that coatings for nuts and bolts do not easily shear off upon tightening/loosening the fasteners.

Generally in the art, adhesion has been achieved by roughening the metal substrate prior to application of the non-stick coating so that mechanical bonding will assist chemical interaction of binders in a primer layer in promoting adhesion. However, some applications require a one-coat solution such that a primer approach is not feasible. Typical roughening includes acid-etching, sanding, grit-blasting, and brushing. Such treatments are a partial but insufficient solution to the adhesion problem.

Current commercial products in use for corrosion resistant coatings for fasteners in seawater applications are predominantly solvent borne or have very high levels of solvent, which is undesirable from a health and environmental perspective. Such compositions typically comprise a fluoropolymer blended with an epoxy resin to aid in toughness and corrosion resistance. Epoxy resins are also undesirable from an environmental perspective, particularly those derived from Bisphenol A (BPA). As an alternative approach, U.S. Pat. No. 4,383,075 discloses an aqueous dispersed thermosetting coating composition comprising a high Tg acrylic latex polymer, a melamine resin, and a polyvinylidene fluoride polymer. However, the formulations disclosed require a very high level of volatile organic compounds (VOC), which are increasingly regulated. Accordingly, despite this disclosure, a need exists for improved aqueous compositions that provide coatings with superior corrosion resistance while maintaining both good coating-substrate adhesion and the ability to release (coating-coating release) so that the fasteners can be unscrewed, even after exposure to salt water environments.

### SUMMARY OF THE INVENTION

The present invention addresses the need for a durable coating for fasteners having superior corrosion resistance while maintaining both good coating-substrate adhesion and the ability to release (coating-coating release) so that the fasteners can be unscrewed, even after exposure to salt water environments. The present invention utilizes a functionalized acrylic polymer and a melamine resin to provide the main binder component of the coating; a perfluorinated polymer which functions as a dry lubricant in the dry coating, and a dispersing and stabilizing resin to aid in fluoropolymer compatibility in both the wet formulation for formulating and shelf stability, and also in the dry coating in order to maximize corrosion resistance.

Specifically, the invention provides an aqueous coating composition comprising, based on weight percent of solids expressed as a percentage of the total weight of solids in the composition: (a) 20-90 weight % of one or more functionalized acrylic polymer; (b) 1-30 weight % of one or more melamine resin; (c) 5-30 weight % of one or more perfluorinated polymer; and (d) 1-35 weight % of one or more dispersing polymer selected from the group consisting of polyimide (PI), polyamideimide (PAI), polyether sulfone (PES), polyphenylene sulfide (PPS), and a mixture thereof.

In an embodiment, the functionalized acrylic polymer has hydroxyl, carboxyl or amide functionality.

In an embodiment, the functionalized acrylic polymer comprises a phosphorus containing monomer.

In an embodiment, the functionalized acrylic polymer has a Tg of from 0° C. to less than 50° C. In an embodiment, the functionalized acrylic polymer has a Tg of from 10° C. to less than 25° C.

In an embodiment, the one or more perfluorinated polymer of the aqueous coating composition comprises polytetrafluoroethylene (PTFE).

In another embodiment, the one or more perfluorinated polymer of the aqueous coating composition comprises only polytetrafluoroethylene (PTFE). In one such embodiment, the one or more perfluorinated polymer of the aqueous coating composition comprises a mixture of two or more polytetrafluoroethylene (PTFE) polymers.

In another embodiment, the one or more perfluorinated polymer of the aqueous coating composition comprises a mixture of two or more perfluorinated polymers. In one embodiment of this type, two of the two or more perfluorinated polymers differ in particle size. In one embodiment of this type, the one or more perfluorinated polymer comprises two perfluorinated polymers that differ in average particle size, d₅₀, by a factor of 5 or greater; in an embodiment, they differ in average particle size by a factor of from 5 to 5,000, or by a factor of from 5 to 200, or by a factor of from 5 to 20. In another embodiment of this type, two of the two or more perfluorinated polymers differ in melt viscosity. In an embodiment, two of the two or more perfluorinated polymers differ in melt viscosity by a factor of 5 or greater; in an embodiment, they differ in melt viscosity by a factor of from 5 to 10⁷; or differ by a factor of from 5 to 200; or differ by a factor of from 10 to 100.

In yet another embodiment, the dispersing polymer of the aqueous coating composition is polyamideimide (PAI), polyamic acid polymer or a salt thereof.

In an embodiment, the aqueous coating composition further comprises an inorganic filler or pigment, or mixture thereof. In an embodiment of this type, the inorganic filler or pigment may comprise titanium dioxide, zinc phosphate, zinc aluminum phosphate or calcium zinc phosphate, or combination thereof.

In an embodiment, the aqueous coating composition further comprises an inorganic corrosion inhibitor or an organic corrosion inhibitor, or combination thereof. In one such embodiment, the inorganic corrosion inhibitor is an orthophosphate silicate comprising one or more of zinc, calcium, strontium or aluminum. Preferably, the inorganic corrosion inhibitor is Heucophos™ ZCP, a zinc calcium strontium aluminum orthophosphate silicate hydrate, available from Heubach GmbH, Langelsheim, Germany. Preferably, the organic corrosion inhibitor is a zinc salt of an organic nitro compound, such as Heucorin™ RZ, a zinc-5-nitroisophthalate, available from Heubach GmbH, Langelsheim, Germany.

In an embodiment, the invention provides an aqueous coating composition comprising, based on weight percent of solids expressed as a percentage of the total weight of solids in the composition: (a) 20-90 weight % of one or more functionalized acrylic polymer; (b) 1-30 weight % of one or more melamine resin; (c) 5-30 weight % of one or more fluoropolymer; and (d) 1-35 weight % of one or more dispersing polymer selected from the group consisting of polyimide (PI), polyamideimide (PAI), polyether sulfone (PES), polyphenylene sulfide (PPS), and a mixture thereof. In one such embodiment, the one or more fluoropolymer of the aqueous coating composition comprises one or more perfluorinated polymer. In one such embodiment, the perfluorinated polymer is polytetrafluoroethylene (PTFE).

The invention also provides a coating on a substrate resulting from application of the aqueous coating composition of any of the above embodiments on the substrate followed by subsequent drying and curing. In an embodiment of this type, the substrate may be made of a metal or metal alloy, such as, for example, steel. In an embodiment, the substrate has been pretreated with a corrosion barrier, such as, for example, phosphated steel. In an embodiment, the substrate is a metal or metal alloy fastener, such as a steel fastener.

This invention also discloses the use of these coating compositions as corrosion resistant coatings on metal or metal alloy fasteners, such as steel fasteners.

Embodiments of the present invention as described in the Summary of the Invention include any other embodiments described herein, can be combined in any manner, and the descriptions of variables in the embodiments pertain not only to the compositions of the present invention, but also to the coated substrates and methods for manufacturing coated substrates of the present invention.

### DETAILED DESCRIPTION OF THE INVENTION

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. For example, when a range of “1 to 5” is recited, the recited range should be construed as including ranges “1 to 4”, “1 to 3”, “1-2”, “1-2 & 4-5”, “1-3 & 5”, and the like. Where a range of numerical values is recited herein, unless otherwise stated, the range is intended to include the endpoints thereof, and all integers and fractions within the range. It is not intended that the scope of the invention be limited to the specific values recited when defining a range.

By “fluoropolymer” it is meant a polymer or copolymer with a backbone comprising repeat units of at least one polymerized monomer comprising at least one fluorine atom. The term “highly fluorinated” means that at least 90% of the total number of halogen and hydrogen atoms attached to the polymer backbone and side chains are fluorine atoms. In some embodiments, the polymer is “perfluorinated”, which means 100% of the total number of halogen and hydrogen atoms attached to the backbone and side chains are fluorine atoms.

Herein, the term “polyamideimide” (or “PAI”) also includes polyamic acid polymer and salts of polyamic acid polymer from which polyamideimide may be derived.

Herein, weight % means the weight percent of solids of a component expressed as a percentage of the total weight of solids of all components in the composition.

Herein, the term “average particle size” is defined as a given particle size where, in a given volume of particles, 50% of the total volume of particles have a particle size smaller than or equal to the given particle size, and is defined by the parameter, d₅₀, being equal to the given particle size. For instance, d₅₀=0.15 micrometers means the total volume of the particles whose particle size is smaller than or equal to 0.15 micrometers is 50%. Particle size is defined herein as a given particle size where, in a given volume of particles, 100% of the total volume of particles have a particle size smaller than or equal to the given particle size, and is defined by the parameter d₁₀₀ being equal to the given particle size. For instance, d₁₀₀=0.30 micrometers means the total volume of the particles whose particle size is smaller than or equal to 0.30 micrometers is 100%, in other words all the particles are smaller or equal to 0.30 micrometers. In an embodiment, the one or more perfluorinated polymer comprises two perfluorinated polymers that differ in average particle size, d₅₀, by a factor of 5 or greater; in an embodiment, they differ in average particle size by a factor of from 5 to 5,000, or by a factor of from 5 to 200, or by a factor of from 5 to 20.

Herein, unless otherwise stated, the term “(co)polymer” includes homopolymers and copolymers.

Herein, unless otherwise stated, the term “(meth)acrylates” includes acrylates and methacrylates and combinations thereof; and the term “(meth)acrylic acid” includes acrylic acid and methacrylic acid and combinations thereof.

Herein, the term “acrylic polymer” includes styrene-acrylic polymers, and means polymers comprising polymerized units of (meth)acrylates or (meth)acrylic acid or styrene, or combinations thereof, at a level of at least 50% by weight of solids as a percentage of the total weight of solids of the (co)polymer. The term “acrylic polymer” therefore includes both homopolymers and copolymers. It does not include the homopolymer polystyrene.

Herein, “glass transition temperature”, Tg, is measured as known in the art by differential scanning calorimetry, DSC, by the half height method of the heat transition.

Herein, DI water means deionized water.

The aqueous coating composition of the invention comprises one or more functionalized acrylic polymer, which may be an emulsion polymer or a resin dispersed in an aqueous medium. Emulsion polymers are preferred. The acrylic polymer, crosslinked with an aminoplast or melamine resin, forms the primary binder in the coating. Preferably, the crosslinking with the melamine component is effected by functionality on the acrylic polymer, which may, for example, take the form of one or more of hydroxyl, carboxyl or amide functionality. Methods to prepare acrylic emulsion polymers are well known in the art, and such emulsions are commercially available from global suppliers, for example, the Rhoplex™, Maincote™ and Avanse™ line of acrylic emulsion polymers from The Dow Chemical Company (Midland, Mich., USA), or the Joncryl™ line of acrylic emulsion polymers from BASF Group (Ludwigshafen, Germany).

Acrylic polymers may comprise polymerized units of ethylenically unsaturated monomers including acrylates and methacrylates, such as the straight chain or branched C₁-C₂₀ alkyl esters of (meth)acrylic acid, which includes, for example, methyl(meth)acrylate, ethyl(meth)acrylate, propyl(meth)acrylate, butyl(meth)acrylate, 2-ethylhexyl(meth)acrylate, and lauryl(meth)acrylate. Other useful acrylic monomers include 2-hydroxy-ethyl(meth)acrylate, phosphoethyl(meth)acrylate, 1,6-hexanediol di(meth)acrylate, neopentyl glycol di(meth)acrylate, ethylthioethyl(meth)acrylate, glycidyl(meth)acrylate, allyl(meth)acrylate, (meth)acrylic acid, (meth)acrylonitrile, (meth)acrylamide, N-methyl(meth)acrylamide, and N,N-dimethyl(meth)acrylamide. The acrylic monomers can be copolymerized with other ethylenically unsaturated monomers including, for example, vinyl monomers such as 1,3-butadiene, methyl substituted butadienes, diacetone acrylamide, vinyl chloride, vinyl acetate, vinyl versatate, vinyl sulfonic acid, vinyl phosphonic acid, vinyl sulfonamide, vinyl sulfonate, methyl vinyl sulfonate, 4-vinyl benzyl alcohol, N-vinyl prrolidone, vinyl pyridine, styrene, alpha-methyl styrene, tertiary butyl styrene, vinyl toluene, and divinyl benzene.

The glass transition temperature, Tg, of the acrylic polymer may be from 0° C. to 100° C., or from 0° C. to less than 50° C., or from 10° C. to 40° C., or from 10° C. to 25° C.

The one or more acrylic polymer (a) is present at a level of from 20 to 90 weight %, or a level of from 25 to 70 weight %, or a level of from 25 to 50 weight %.

The acrylic polymer containing one or more functionality capable of reacting with an aminoplast resin can be reacted with the melamine resin upon heating to produce a crosslinked polymeric structure. Herein, the term “melamine resins” includes melamine-formaldehyde or other aminoplast resins including melamine or melamine derivatives such as methylol melamine or similar alkylated melamine-formaldehyde reactive resins. Suitable melamine resins for the invention include Luwipal™ resins available from BASF Group (Ludwigshafen, Germany); or Cymel™ melamine resins from Cytec Industries, Inc. (Brussels, Belgium). The one or more melamine resin (b) is present at a level of from 1 to 30 weight %, or a level of from 5 to 25 weight %, or a level of from 10 to 25 weight %.

The perfluorinated polymers for use in this invention can be a non melt-fabricable fluoropolymer with a melt viscosity of at least 1×10⁷ Pa·s. One embodiment is polytetrafluoroethylene (PTFE) having a melt viscosity of at least 1×10⁸ Pa·s at 380° C. Such PTFE can also contain a small amount of comonomer modifier which improves film-forming capability during baking (fusing), such as perfluoroolefin, notably hexafluoropropylene (HFP) or perfluoro(alkyl vinyl)ether, notably wherein the alkyl group contains 1 to 5 carbon atoms, with perfluoro(propyl vinyl ether) (PPVE) being preferred. The amount of such modifier will be insufficient to confer melt-fabricability to the PTFE, generally being no more than 0.5 mole %. The PTFE, also for simplicity, can have a single melt viscosity, usually at least 1×10⁹ Pa·s, but a mixture of PTFEs having different melt viscosities can be used to form the perfluorinated polymer component.

The perfluorinated polymers can also be melt-fabricable fluoropolymer, either combined (blended) with the PTFE, or in place thereof. Examples of such melt-fabricable fluoropolymers include copolymers of TFE and at least one perfluorinated copolymerizable monomer (comonomer) present in the polymer in sufficient amount to reduce the melting point of the copolymer substantially below that of TFE homopolymer, polytetrafluoroethylene (PTFE), e.g., to a melting temperature no greater than 315° C. Preferred comonomers with TFE include the perfluorinated monomers such as perfluoroolefins having 3-6 carbon atoms and perfluoro(alkyl vinyl ethers) (PAVE) wherein the alkyl group contains 1-5 carbon atoms, especially 1-3 carbon atoms. Especially preferred comonomers include hexafluoropropylene (HFP), perfluoro(ethyl vinyl ether) (PEVE), perfluoro(propyl vinyl ether) (PPVE) and perfluoro(methyl vinyl ether) (PMVE). Preferred TFE copolymers include FEP (TFE/HFP copolymer), PFA (TFE/PAVE copolymer), TFE/HFP/PAVE wherein PAVE is PEVE and/or PPVE and MFA (TFE/PMVE/PAVE wherein the alkyl group of PAVE has at least two carbon atoms). The molecular weight of the melt-fabricable tetrafluoroethylene copolymers is unimportant except that it be sufficient to be film-forming and be able to sustain a molded shape so as to have integrity in the coating application. Typically, the melt viscosity will be at least 1×10² Pa·s and may range up to about 60-100×10³ Pa·s as determined at 372° C. according to ASTM D-1238.

In an embodiment, the perfluorinated polymer component is a blend of non melt-fabricable fluoropolymer with a melt viscosity in the range from 1×10⁷ to 1×10¹¹ Pa·s and melt fabricable fluoropolymer with a viscosity in the range from 1×10³ to 1×10⁵ Pa·s.

The perfluorinated polymer component is generally commercially available, either as a powder, or as a dispersion of the polymer in water. By “dispersion” is meant that the perfluorinated polymers particles are stably dispersed in the aqueous medium, so that settling of the particles does not occur within the time when the dispersion will be used. This may be achieved by utilizing a small size of fluoropolymer particles, typically on the order of 0.2 micrometers, and the use of surfactant in the aqueous dispersion by the dispersion manufacturer. Such dispersions can be obtained directly by the process known as dispersion polymerization, optionally followed by concentration and/or further addition of surfactant.

Useful perfluorinated polymers also include those commonly known as micropowders. These fluoropolymers generally have a melt viscosity 1×10² Pa·s to 1×10⁶ Pa·s at 372° C. Such polymers include but are not limited to those based on the group of polymers known as tetrafluoroethylene (TFE) polymers. The polymers may be directly polymerized or made by degradation of higher molecular weight PTFE resins. TFE polymers include homopolymers of TFE (PTFE) and copolymers of TFE with such small concentrations of copolymerizable modifying comonomers (<1.0 mole percent) that the resins remain non-melt-processible (modified PTFE). The modifying monomer can be, for example, hexafluoropropylene (HFP), perfluoro(propyl vinyl)ether (PPVE), perfluorobutyl ethylene, or other monomer that introduces side groups into the molecule.

Fluoropolymers comprising polymerized units of fluorohydrocarbon monomers, such as polyvinylfluoride and polyvinylidenefluoride, or comprising polymerized units of perfluorinated monomers together with monomers that are not perfluorinated, such as polyethylene-tetrafluoroethylene copolymer, may also find utility in the aqueous coating compositions as additional components. However, perfluorinated fluoropolymers, or a mixture of two or more perfluorinated polymers, are preferred. A particularly suitable perfluorinated polymer is polytetrafluoroethylene (PTFE), or a mixture of two or more polytetrafluoroethylene (PTFE) polymers.

It is specifically preferred that the perfluorinated polymer component comprises a perfluorinated polymer that does not form a continuous phase throughout the polymer coating film. After the initial film formation and cure, this perfluorinated polymer is present as discrete particles, which latter may have some mobility in the film. Accordingly, the polymer film in use may not have an homogeneous distribution of the perfluorinated polymer component throughout the film. The perfluorinated polymer may be present in the polymer film at a greater concentration near the film surface, which is advantageous with respect to tightening and loosening the fasteners.

The fluoropolymer used in the invention may be purchased in the markets. For example, it may be purchased from DuPont Company (Wilmington, Del., USA) in the trade names of either Teflon® or Zonyl®.

The one or more perfluorinated polymer (c) is present at a level of from 5 to 30 weight %, or a level of from 10 to 25 weight %, or a level of from 15 to 25 weight %.

The dispersing polymer component of the present invention is thermally stable and film-forming upon heating to fusion, and aids in film-forming within and as part of the layer. Examples of such dispersing polymers include one or more: (1) polysulfones, which are amorphous thermoplastic polymers with a glass transition temperature of about 185° C.; (2) polyethersulfones (PES), which are amorphous thermoplastic polymers with a glass transition temperature of about 230° C.; (3) polyimides (P1), polyamide imides (PAI) and/or polyamic acid salt which converts to polyamideimide, which imides crosslink upon heating of the coating to fuse it, among others. Other polymers that may find utility in this respect include polyphenylene sulfide (PPS), polyarylene-ether-ketone, polyetherimide, and poly(1,4(2,6-dimethylphenyl)oxide) commonly known as polyphenylene oxide (PPO). In an embodiment, a small quantity of organic solvent may be added along with the dispersing binder for ease of addition and to aid in the film formation. Such solvents include N-methylpyrrolidone (NMP), dimethylformamide, dimethylacetamide, dimethylsulfoxide, and cresylic acid, which will depend on the particular dispersing polymer being used. NMP is a preferred solvent because of its relative safety and environmental acceptability. One skilled in the art will recognize that mixtures of solvents can be used. One skilled in the art will also recognize the possibility of using mixtures of high temperature resistant dispersing polymers in the practice of this invention. Multiple dispersing polymers may be contemplated for use in this invention, especially when a balance of properties is desired, such as flexibility, hardness, corrosion resistance and especially sprayability.

An example of a preferred dispersing polymer is polyamide imide (PAI), or polyamic acid polymer or salt thereof, dissolved into a solvent such as N-methylpyrolidone prior to adding to the composition. In an embodiment, the polyamideimide has a number average molecular weight of no greater than about 20,000, and preferably no greater than 15,000. In another embodiment, which is especially suitable for producing thicker films, the polyamideimide has a number average molecular weight of greater than about 15,000, and preferably greater than 20,000.

The polyamideimide can be purchased from the markets. For instance, polyamideimide resins can be purchased from the Hitachi Chemical Company (Japan), for example, product serial numbers HPC-6000A-26D, HPC-6000A-28, HPC-1000-28 and HI-680. Polyamic acid solutions may also be used, such as Polyamic Acid A-10 from Amoco (BP group, London, UK). Polyethersulfone can be purchased in the trade names of Radel™ A-304P or Radel™ A-704P from Solvay Advanced Polymers L.L.C (Dusseldorf, Germany); alternatively, polyethersulfone powders can also be purchased in the trade name of PES 4100mp from Sumitomo Chemical Co., Ltd. (Tokyo, Japan). Polyphenylene sulfide is available as the resin Ryton™ V-1 (Conoco-Phillips, Houston, Tex., USA).

The dispersing polymer component of the present invention (d) is present at a level of from 1 to 35 weight %, or a level of from 1 to 20 weight %, or a level of from 1 to 10 weight %.

The aqueous coating composition may comprise either one or more inorganic filler, or one or more inorganic pigment, or a combination thereof. The inorganic filler and pigment particles are one or more filler or pigment type materials which are inert with respect to the other components of the composition and thermally stable at its cure temperature which fuses the perfluorinated polymer and binder. The filler is water insoluble so that it is typically uniformly dispersible but not dissolved in the aqueous dispersion of the composition of the invention.

Suitable fillers and pigments as known in the art may be utilized including particles of calcium carbonate, aluminum oxide, calcined aluminum oxide, silicon carbide etc. as well as glass flake, glass bead, glass fiber, aluminum or zirconium silicate, mica, metal flake, metal fiber, fine ceramic powders, silicon dioxide, barium sulfate, talc, etc. Preferred fillers/pigments include titanium dioxide and metal phosphates and mixed metal phosphates such as zinc phosphate, zinc aluminum phosphate and calcium zinc phosphate. Surface pre-treated pigments as known in the art are commonly available from manufacturers and generally these are also suitable. The levels of fillers and pigments is not particularly limited although high levels, for example, a level in combination of greater than 50% by weight of total solids, are usually unsuitable for corrosion resistant coatings. Preferably the combined weight percent of pigments and fillers, as a percentage of the total weight of solids in the composition, is less than 30%, and more preferably less than 25%; most preferably it is between 10% and 25%. In an embodiment, organic or inorganic liquid colorants may be used in addition to, or in place of, solid pigments. Color acceptance is an important property for marine fasteners, since many manufacturers require the marine fastener coatings to be blue. The inventive compositions described herein show good color acceptance. In another embodiment the coating composition does not include either solid pigments or colorants.

The aqueous coating composition may further comprise an inorganic corrosion inhibitor or an organic corrosion inhibitor, or combination thereof. A suitable inorganic corrosion inhibitor is an orthophosphate silicate comprising one or more of zinc, calcium, strontium or aluminum. Preferably, the inorganic corrosion inhibitor is Heucophos™ ZCP, a zinc calcium strontium aluminum orthophosphate silicate hydrate, available from Heubach GmbH, Langelsheim, Germany. A suitable organic corrosion inhibitor is a zinc salt of an organic nitro compound, such as Heucorin™ RZ, a zinc-5-nitroisophthalate, available from Heubach GmbH, Langelsheim, Germany.

Methods of formulating such compositions are well known in the art. Although coalescents may be used, they are not required because the high temperatures used in drying and curing the composition may also be sufficient to achieve appropriate film formation for the main polymeric binder. The formulation ingredients may be combined using mechanical stirrers as known in the art, and addition of pigments and fillers may be more effectively accomplished using known high speed and/or high shear techniques using high shear stirrers such as, for example, a Cowles mixer.

The compositions of the present invention can be applied to substrates by conventional means. Spray applications are the most convenient application methods. Other well-known coating methods including dipping, brushing and coil coating are also suitable.

The substrate is preferably a metal for which corrosion resistance of the coated substrate is increased by the application of the inventive coating composition. Examples of useful substrates include aluminum, anodized aluminum, carbon steel, and stainless steel. As noted above, the invention has particular applicability to steel, such as cold rolled steel, and particularly for steel fasteners. Preferably, the substrate is pre-treated by methods which withstand the cure temperature of the coating, such as, for example, phosphate, zinc phosphate, or manganese phosphate treatments, and others as known in the art.

Prior to applying the coating composition, the substrate is preferably cleaned to remove contaminants and grease which might interfere with adhesion. Conventional soaps and cleansers can be used for cleaning. The substrate can be further cleaned by baking at high temperatures in air, at temperatures of 800° F. (427° C.) or greater. Preferably, the substrate is then grit-blasted; for example, preferably resulting in a surface roughness of 1-4 micrometers, or 3-4 micrometers. The cleaning and/or grit-blasting steps enable the coating to better adhere to the substrate.

In a preferred embodiment the coating is applied by spraying. The coating is applied to a dried film thickness (DFT) of greater than about 10 micrometers, preferably greater than about 12 micrometers and in other embodiments in ranges of about 10 to about 30 micrometers; and, preferably, about 18 to about 25 micrometers. The coating composition may be used as a single coat. However, the thickness of the coating affects the corrosion resistance. If the coating is too thin, the substrate will not be fully covered resulting in reduced corrosion resistance. If the coating is too thick, the coating will crack or form bubbles resulting in areas that will allow salt ion attack and therefore reduce corrosion resistance. The aqueous composition is applied and then dried to form the coating. Drying and curing temperature will vary based on the composition, for example, from 110° C. to 250° C., but for example may be typically a drying temperature of 120° C. for 15 minutes followed by cure at 230° C. for 25 minutes. Further coating layers may be applied, although this invokes additional heat/cure cycles; each coating layer may be dried at 120° C. for 15 minutes, and the substrate allowed to cool between coating applications, prior to final cure, which may be the same as that for the one-coat cure (230° C. for 25 minutes).

Clean up and dilution may be accomplished by DI water.

The invention provides aqueous coating compositions for metal substrates, where the coating provides improved corrosion resistance compared to conventional aqueous corrosion resistant coatings. The composition is particularly useful for fasteners, such as nuts and bolts, used in marine environments.

The invention provides an aqueous coating composition comprising, based on weight percent of solids expressed as a percentage of the total weight of solids in the composition: (a) 20-90 weight % of one or more functionalized acrylic polymer; (b) 1-30 weight % of one or more melamine resin; (c) 5-30 weight % of one or more perfluorinated polymer; and (d) 1-35 weight % of one or more dispersing polymer selected from the group consisting of polyimide (PI), polyamideimide (PAI), polyether sulfone (PES), polyphenylene sulfide (PPS), and a mixture thereof.

In an embodiment, the one or more functionalized acrylic polymer (a) is present at a level of from 20 to 70 weight %, or a level of from 25 to 50 weight %; the one or more melamine resin (b) is present at a level of from 5 to 30 weight %, or a level of from 15 to 25 weight %; the one or more perfluorinated polymer (c) is present at a level of from 10 to 25 weight %, or a level of from 10 to 20 weight %; and the one or more dispersing polymer (d) is present at a level of from 1.0 to 25 weight %, or a level of from 2.0 to 10 weight %. The ranges of each component are independently combinable, for example the acrylic polymer may be present at a level of from 25 to 70 weight %.

The materials, methods, and examples herein are illustrative only and, except as specifically stated, are not intended to be limiting. Although methods and materials similar or equivalent to those described herein can be used in the practice or testing of the present invention, suitable methods and materials are described herein.

### Test Methods

Corrosion Resistance Test: The corrosion resistance of the paint films was determined using the Corrosion Resistance Test, as described by ASTM procedure B-117/D174 (Salt Fog Spray Test).

Each formulated paint was applied by spraying phosphate treated cold rolled steel panels that had been washed to remove grease and then grit blasted. The coating was permitted to dry by forced air drying at a temperature of 120° C. for 15 minutes, followed by cure at 230° C. for 25 minutes. The dried coating thickness (DFT) of the applied coating was approximately 20 microns (+/−1 micrometer) as measured with a film thickness instrument, e.g., Isoscope, based on the eddy-current principle (ASTM B244). The test panels are placed in enclosed Salt Fog Spray Test apparatus (the “Q-FOG”, Q-Panel Laboratory Products, 26200 First Street, Cleveland, Ohio) for a period of 1,000 hours, 1,500 hours, and 2,000 hours, and, after each time period, they were removed, dabbed with a dry cloth to dry, and then visually inspected to evaluate for rusting (expressed as a percent of panel that has rusted). Testing is ceased if the panels show 15% rusting or more, or if the film blisters or cracks. These conditions are indicative of coating failures.

Pencil Hardness Test (with Scale for Results):

The hardness of the paint films was assessed by pencil hardness, a standard industry test. Pencils of a range of hardness (from soft to hard: 4B, 3B, 2B, HB, F, H, 2H, 3H, 4H, 5H; Pencil: Uni, MITSU-BISHI) are prepared with approximately 3 mm of lead exposed.

Test panels are prepared with the test coatings. Starting with the softest pencil, the pencil point is moved forward on the coating surface at an angle of 45. The mark is examined with a magnifier or microscope to see if the lead has cut into the film. The procedure is followed with pencils of increasing hardness until the first pencil that cuts into the film is identified. The hardness rating of the previous pencil is the rated hardness of the film.

### Crosshatch Adhesion Test (ASTM D3359):

The test procedure follows that of ASTM D3359. The steel panels are coated as described above, and the dry paint film is scored with a blade through the coating with a grid template having 1 mm spacings. Adhesive tape (Scotch Tape, 3M, St. Pail, Minn., USA) is pressed down evenly on each coating surface over the scored area, and then pulled up evenly at a 90 degree angle. Adhesion to the substrate was evaluated according to the amount of the paint film that is removed by the tape (expressed as a percentage).

### Coefficient of Friction Test:

The test procedure follows that of ASTM D1894. In the examples below, the static coefficient of friction was determined.

### EXAMPLES

TABLE 1
Coating Formulation (Formulation 1)

| | Wt % | Wt % |
|---|---|---|
| Ingredients | (Wet) | (solids) |
| Water | 12.6 | 0.0 |
| Acrylic resin¹ | 34.4 | 30.8 |
| Melamine resin² | 11.4 | 23.3 |
| Perfluorinated polymer Additive 1, PTFE³ | 7.7 | 15.9 |
| Perfluorinated polymer Additive 2, PTFE⁴ | 1.8 | 3.6 |
| Polyamic Acid Polymer⁵ (PAI) | 4.9 | 2.8 |
| N-methyl-2-pyrrolidone | 5.2 | 0.0 |
| Cosolvents/Alcohols | 10.4 | 0.0 |
| Nonionic surfactants | 1.6 | 3.0 |
| Pigments/Fillers | 10.0 | 20.6 |
| Total | 100 | 100 |

¹Joncryl ™ 8300, acrylic emulsion with 1.3% —OH functionality on solids; 43.5% solids; Tg = 20° C.; available from BASF Group, Ludwigshafen, Germany.
²Luwipal ™ 066, BASF Group, Ludwigshafen, Germany.
³Zonyl ™ MP1600N, PTFE powder; available from E. I. DuPont de Nemours and Company, Wilmington, DE, USA.
⁴Zonyl ™ MP1000, PTFE powder; available from E. I. DuPont de Nemours and Company, Wilmington, DE, USA.
⁵Polyamic Acid Polymer, available from E. I. DuPont de Nemours and Company, Wilmington, DE, USA.

### Example 1

The inventive coating composition was compared with the leading commercially available corrosion resistant coating (C1) for this application (industrial fasteners) in a standard corrosion resistance test (Salt Fog Spray, ASTM B-1171D174). Each formulated paint was applied by spraying phosphate treated cold rolled steel panels that had been washed to remove grease and then grit blasted. The coating was permitted to dry by forced air drying at a temperature of 120° C. for 15 minutes, followed by cure at 230° C. for 25 minutes. The dried coating thickness (DFT) of the applied coating was approximately 20 microns (+/−1 micrometer) as measured with a film thickness instrument, e.g., Isoscope, based on the eddy-current principle (ASTM B244).

The panels were subjected to corrosion resistance and hardness testing as described above under Test Methods (results in Table 2).

The comparative C1 coating showed marked deterioration after 1,000 hours of salt fog spray testing, with more than 80% of the panel showing red rust, whereas the coating of the inventive formulation (Formulation 1, Table 1) was minimally effected after the same testing, with less than 5% of the coated area showing red rust via occasional scattered pin-holes (Table 2). The comparative C1 coating continued to deteriorate up to 1,500 hours and up to 2000 hours, whereas the inventive coating remained little changed.

TABLE 2
Corrosion Resistance and Hardness for Coatings

| | Comparative | Inventive |
|---|---|---|
| Corrosion resistance (1,000 hours) | >80% fail | <5% fail |
| Pencil hardness (room temp) | 5H | 5H |

The coating of the invention shows much better corrosion resistance than the comparative C1 coating produced from the commercially available corrosion resistant paint.

### Perfluorinated Polymer:

The effect of perfluorinated polymer component was evaluated by comparing similar inventive formulations (Table 1), where both formulations comprise two fluoropolymer additives, and wherein the only difference in the formulations was the second fluoropolymer additive component. Below, the inventive Formulation 1 shown in Table 1, and the formulation (C2) are identical except that the perfluorinated polymer additive 2 component (PTFE) was replaced with ETFE (ethylene-tetrafluoroethylene copolymer). Formulation 1 comprises only perfluorinated fluoropolymers, whereas C2 comprises non-perfluorinated fluoropolymers. The coatings were compared for their coefficient of friction (using ASTM D1894), which is a measure of the release properties of the coated fasteners, allowing them to be tightened and loosened, Table 3.

TABLE 3
Coefficient of Friction for Coatings

| Coating | Coefficient of Friction |
|---|---|
| Coating of Formulation 1 | 0.143 |
| (perfluorinated fluoropolymer) | |
| Coating of C2 (non-perfluorinated fluoropolymer) | 0.250 |

The coefficient of friction is superior for Formulation 1 comprising only perfluorinated fluoropolymer additives compared to the formulation comprising fluoropolymers that are not perfluorinated.

The lower coefficient of friction translates to improved release properties in the final coated product. In the case of conventional coatings, improved release translates to better “block” resistance (block is the tendency of two coated substrates to stick. For example, a painted window frame in contact with a painted window casing; if the coating has poor block, the window will stick and cannot be opened). In the case of coated fasteners, improved release properties equates to improved ability to unscrew the nuts and bolts.

### Effect of Dispersing Polymer:

Formulations were compared with and without the dispersing polymer component. Coatings from Inventive Formulation 1 (above) were compared to coatings from a comparative (C3) having identical formulation but without the PAI component. Formulation 1 had improved sprayability and shelf life stability compared to the comparative formulation. Moreover, the coating from Inventive Formulation 1 showed improved adhesion to the substrate after exposure to salt fog spray as measured by the crosshatch adhesion test (described earlier), Table 4.

TABLE 4
Tape adhesion pull for coatings

| Coating | % of Coating Removed |
|---|---|
| Coating of Formulation 1 (with PAI) | 0% |
| Coating of C3 (without PAI) | approx. 5% |

### Example 2

Corrosion resistant coatings of the invention were found to possess a good balance of properties required for fastener coatings used in marine environments. Representative of these, the formulations in Table 1 (above) and Tables 5-6 (below) showed exemplary performance in salt spray corrosion resistance testing (greater than 1,000 hours without rust/blistering/cracking failure modes for coatings of phosphate treated cold rolled steel substrates), as well as good hardness and fastener release properties.

TABLE 5
Coating Formulation (Formulation 2)

| | Wt % | Wt % |
|---|---|---|
| Ingredients | (Wet) | (solids) |
| Water | 19.1 | 0.0 |
| Acrylic resin¹ | 31.3 | 35.8 |
| Melamine resin² | 7.6 | 19.8 |
| Perfluorinated polymer, PTFE³ | 6.7 | 17.6 |
| Polyamic Acid Polymer⁴ (PAI) | 3.5 | 2.6 |
| N-methyl-2-pyrrolidone | 4.4 | 0.0 |
| Cosolvents/Alcohols | 17.9 | 0.0 |
| Nonionic surfactants | 2.2 | 5.3 |
| Pigments/Fillers | 7.2 | 18.9 |
| Total | 100 | 100 |

¹Joncryl ™ 8300, acrylic emulsion with 1.3% —OH functionality on solids; 43.5% solids; Tg = 20° C.; available from BASF Group, Ludwigshafen, Germany.
²Luwipal ™ 066, BASF Group, Ludwigshafen, Germany.
³Zonyl ™ MP1600N, PTFE powder; available from E. I. DuPont de Nemours and Company, Wilmington, DE, USA.
⁴Polyamic Acid Polymer, available from E. I. DuPont de Nemours and Company, Wilmington, DE, USA.

TABLE 6
Coating Formulation (Formulation 3)

| | Wt % | Wt % |
|---|---|---|
| Ingredients | (Wet) | (solids) |
| Water | 23.5 | 0.0 |
| Acrylic resin¹ | 26.2 | 26.0 |
| Melamine resin² | 10.1 | 22.6 |
| Perfluorinated polymer Additive 1, PTFE³ | 7.6 | 17.3 |
| Non-perfluorinated Fluoropolymer, ETFE⁴ | 2.2 | 5.1 |
| Polyamic Acid Polymer⁵ (PAI) | 4.4 | 2.8 |
| N-methyl-2-pyrrolidone | 4.7 | 0.0 |
| Cosolvents/Alcohols | 9.7 | 0.0 |
| Nonionic surfactants | 1.4 | 3.0 |
| Pigments/Fillers | 10.2 | 23.3 |
| Total | 100 | 100 |

¹Joncryl ™ 8300, acrylic emulsion with 1.3% —OH functionality on solids; 43.5% solids; Tg = 20° C.; available from BASF Group, Ludwigshafen, Germany.
²Luwipal ™ 066, BASF Group, Ludwigshafen, Germany.
³Zonyl ™ MP1600N, PTFE powder; available from E. I. DuPont de Nemours and Company, Wilmington, DE, USA.
⁴Ethylene-tetrafluoroethylene copolymer, available from E. I. DuPont de Nemours and Company, Wilmington, DE, USA.
⁵Polyamic Acid Polymer, available from E. I. DuPont de Nemours and Company, Wilmington, DE, USA.

What is claimed is:

1. An aqueous coating composition comprising, based on weight percent of solids expressed as a percentage of the total weight of solids in the composition:
(a) 20-90 weight % of one or more functionalized acrylic polymer;
(b) 1-30 weight % of one or more melamine resin;
(c) 5-30 weight % of one or more perfluorinated polymer; and
(d) 1-35 weight % of one or more dispersing polymer selected from the group consisting of polyimide (P1), polyamideimide (PAI), polyether sulfone (PES), polyphenylene sulfide (PPS) and a mixture thereof.

2. The aqueous coating composition of claim 1 wherein the functionalized acrylic polymer has hydroxyl, carboxyl or amide functionality.

3. The aqueous coating composition of claim 1 wherein the functionalized acrylic polymer comprises a phosphorus containing monomer.

4. The aqueous coating composition of claim 1 wherein the functionalized acrylic polymer has a Tg of from 0° C. to less than 50° C.

5. The aqueous coating composition of claim 1 wherein the functionalized acrylic polymer has a Tg of from 10° C. to less than 25° C.

6. The aqueous coating composition of claim 1 wherein the one or more perfluorinated polymer comprises polytetrafluoroethylene (PTFE).

7. The aqueous coating composition of claim 1 wherein the one or more perfluorinated polymer comprises only polytetrafluoroethylene (PTFE).

8. The aqueous coating composition of claim 7 wherein the one or more perfluorinated polymer comprises a mixture of two or more polytetrafluoroethylene (PTFE) polymers.

9. The aqueous coating composition of claim 1 wherein the one or more perfluorinated polymer comprises two perfluorinated polymers that differ in average particle size by a factor of 5 or greater.

10. The aqueous coating composition of claim 1 wherein the one or more perfluorinated polymer comprises two perfluorinated polymers that differ in melt viscosity size by a factor of 5 or greater.

11. The aqueous coating composition of claim 1 wherein the dispersing polymer is polyamideimide (PAI), polyamic acid polymer, or salt thereof.

12. The aqueous coating composition of claim 1 further comprising an inorganic filler or pigment, or mixture thereof.

13. The aqueous coating composition of claim 12 wherein the inorganic filler or pigment comprises titanium dioxide, zinc phosphate, zinc aluminum phosphate or calcium zinc phosphate, or combination thereof.

14. The aqueous coating composition of claim 1 further comprising an inorganic corrosion inhibitor or an organic corrosion inhibitor, or combination thereof.

15. The aqueous coating composition of claim 1 further comprising an orthophosphate silicate comprising one or more of zinc, calcium, strontium or aluminum.

16. The aqueous coating composition of claim 1 further comprising a zinc salt of an organic nitro compound.

17. A coating on a substrate resulting from application of the aqueous coating composition of claim 1 on said substrate followed by subsequent drying and curing.

18. The coating of claim 17 wherein the substrate is a metal or metal alloy.

19. The coating of claim 17 wherein the substrate is a metal or metal alloy fastener.

20. Use of the coating composition of claim 1 as a corrosion resistant coating on a metal or metal alloy fastener.
